(19) United States
(12) Patent Application Publication
(10) Pub. No.: US 2005/0240773 A1
(43) Pub. Date: Oct. 27, 2005

(54) Secure file sharing

(75) Inventors: David M. Hilbert, Palo Alto, CA (US); Jonathan J. Trevor, Santa Clara, CA (US)

Correspondence Address: Martin C. Fliesler;FLIESLER MEYER LLP, Fourth Floor, Four Embarcadero Center, San Francisco, CA, 94111-4156, US

(73) Assignee: Fuji Xerox Co., Ltd., Tokyo (JP)

(21) Appl. No.: 10/828,991

(22) Filed: Apr. 21, 2004

(51) Int. Cl. H04K 1/00

(52) U.S. Cl. 713/182

(57) ABSTRACT

The present invention discloses a proxy server that enables remote users to securely share files. A proxy server maintains credentials for accessing files on secure file sources. By sharing a file a user of the file source generates a proxy representation that maintains information about the location of the file and mechanisms for accessing the file. When the recipient submits changes the proxy server executes those changes on the original file.

### FIELD OF THE INVENTION

The current invention relates generally to remote file access and particularly to systems and methods for enabling secure access to shared files.

### BACKGROUND OF THE INVENTION

In the present business environment users are increasingly dependent on access to electronic documents and other files for performing regular business functions. Additionally, as projects have become more collaborative in nature, there has been an increasing need to share files with partners, coworkers, clients, and other potential collaborators. Alternatively, during the same time period there has been an increased emphasis on network security.

This has presented significant impediments to individuals attempting to collaborate with outside parties to develop documents, media, research, and other projects. Parties can email copies of files to one another, but doing so requires that the parties keep track of the changes that have been made to multiple versions of the file. Alternately, users can share the files through conventional network sharing techniques. However, doing so requires that the collaborators be either on the same physical network or connected via a Virtual Private Networking (VPN) connection. Sharing a physical network is often impractical and VPN presents its own difficulties.

Firstly, configuring a client to use VPN requires both administrator level access to the client machine and a lengthy setup procedure.

Additionally, beyond their restrictions in accessing the raw data sources, VPN and similar remote-access solutions often fail to provide a useful interface for accessing the stored files. Users are forced to wade through complicated file hierarchies to access their preferred files, a task which can be especially cumbersome when using slower devices.

File repositories have provided a partial solution to this problem as the files are stored outside the sharer's network. However, copies of files stored on a file repository are disconnected from the original, requiring that any changes be separately updated to the original.

Finally, providing a remote user with VPN access often enables the remote user to access the entire network for which the VPN is enabled, which may present intolerable security risks.

What is needed is a solution that allows users an easy and secure way to share files.

### SUMMARY OF THE INVENTION

The present invention discloses a proxy server that enables remote users to securely share files. A proxy server maintains credentials for accessing files on secure file sources. By sharing a file a user of the file source generates a proxy representation that maintains information about the location of the file and mechanisms for accessing the file. When the recipient submits modifications, the proxy server executes those changes on the original file.

### BRIEF DESCRIPTION OF THE DRAWINGS

FIG. 1 illustrates the interaction among clients, file sources, and a proxy server in accordance with one embodiment of the present invention.

FIG. 2 is a closer view of a client system in accordance with one embodiment of the present invention.

FIG. 3 is a closer view of a file source in accordance with one embodiment of the present invention.

FIG. 4 is a closer view of the components of the memory of the proxy server in accordance with one embodiment of the present invention.

FIG. 5 is a closer view of a user file record in the proxy database in accordance with one embodiment of the present invention.

FIG. 6 is a closer view of a proxy representation.

FIG. 7 is a flow chart illustrating one embodiment of a method for retrieving a shared file.

FIG. 8 is a flow chart illustrating one embodiment of a process for sharing a file with a user by transmitting an electronic mail message.

FIG. 9 is a flow chart illustrating one embodiment of a process for registering a user.

FIG. 10 is a flow chart illustrating one embodiment of a process for sharing a file.

### DETAILED DESCRIPTION

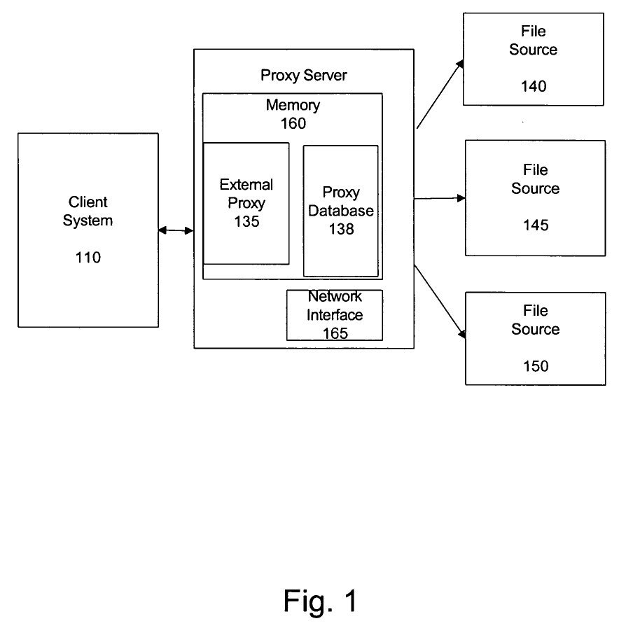

FIG. 1 illustrates the interaction among clients, file sources, and a proxy server in accordance with one embodiment of the present invention. A proxy server 125 is in communication with a group of file sources 140, 145, 150 and a client system 110. The proxy server 125 is a server having memory 160, and a network interface 165 that is configured to enable secure access to the file sources 140, 145, 150 from the client system 110. The proxy server is configured to allow users of the client systems to access files stored on the file sources 140, 145, 150. The proxy server preferably maintains lists of shared files in the form of proxy representations. The proxy representations include lists of users permitted to access the files and the users' levels of access.

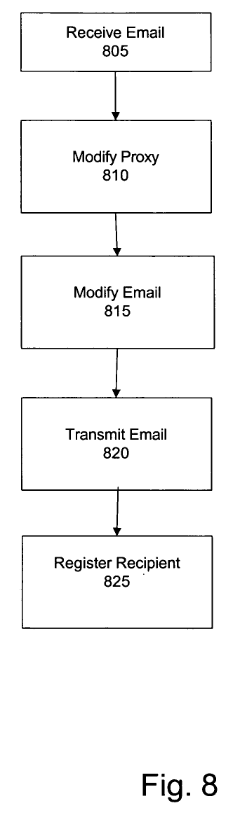

The proxy server 125 is also configured to process email transmissions containing file references or attachments and grant access to original or duplicate versions of the referenced files to the recipient of the message. In one embodiment, the proxy server can receive a proxy generation request from an email client or email client plug-in on a sender computer that submits the request when a user attempts to send a message with an attachment. In an alternate embodiment, the proxy server 125 intercepts a mail message with an attachment, separates the attachment, and inserts a reference to a new proxy representation associated with the attachment in the message. In a third embodiment, the proxy server 125 allows a user to select a file through a mail-sending HTML User Interface (UI), generates a proxy representation for the file, and sends a message including a reference to the proxy representation. The email process is described in greater detail with respect to FIG. 8.

The proxy server includes an external proxy 138 which governs access for the clients and is responsible for maintaining the privileges of remote users. The proxy server also includes a proxy database 135 which stores user records and shared file information.

The file sources 140, 145, 150 are file sources such as stand-alone file servers, file repositories, desktop computers, laptop computers, or any other system upon which files are stored. Users of the file sources can share files stored on the file sources by granting permissions to those files through the proxy server 125. The file sources 140, 145, 150 may employ any of a number of operating systems, including but not limited to: Windows 2000, Windows XP, Linux, Solaris, Netware, or Linux. The proxy server 125 accesses the file sources 140, 145, 150 via its network interface 165, through a LAN, WAN, or a customized dialup connection. The proxy server 125 may be located behind whatever firewall protections the file sources may use. Alternately, the proxy server 125 may use VPN or a customized connection mechanism to reach the file sources 140, 145, 150. The connection mechanism is preferably modular and thus transparent to the client system 110. In some embodiments, the proxy server 125 maintains login credentials which enable it to access data stored on the file sources 140, 145, 150. In alternate embodiments, the proxy server 125 does not store the credentials, but rather uses them to initially store a cached copy of a shared file. When changes are made to the cached copy, the proxy server can notify the file sharer and accept a request to update the original version with the cached version.

The client system 110 is a device remote to the proxy server 125 used to access, manipulate, print, and/or view the files stored on the file sources 140, 145, 150. Typically, a user of the client system is granted permission to access the files stored on the file sources by one of the users of the file sources 140, 145, 150. The client system 110 can be a personal computer, personal data assistant, or any device having file-viewing capacity. The client system 110 establishes a network connection between itself and the proxy server 125 and views the files on the file sources 140, 145, 150 through an interface generated by the client or the proxy server 125. In one embodiment this interface is a web interface. In an alternate embodiment, the proxy server 125 generates a customized interface according to the viewing capacities of the client system 110, or the client system generates the interface itself. If the client is a system with network file sharing capacity such as Microsoft Windows or Linux, the proxy server can integrate with the directory structure of the client, allowing shared files to appear as part of the recipient's directory structure.

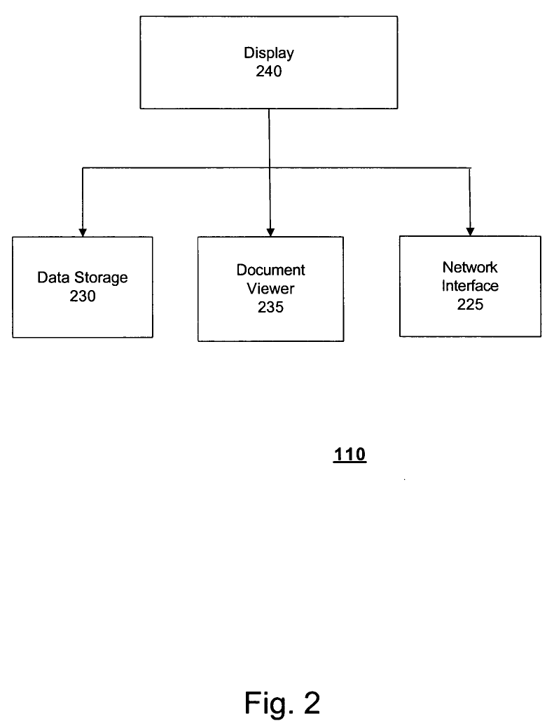

FIG. 2 is a closer view of a client system 110 in accordance with one embodiment of the present invention. The client system is configured to permit an authorized user to access files stored on the file sources 140, 145, 150. The client system 110 includes data storage 230, a document viewer 235, and a network interface 225 and is configured to enable access to shared files. The data storage 230 stores documents and other necessary data locally on the client system 110. The data storage can be a solid state device such as a hard drive. Alternately the data storage can be Static Random Access Memory (SRAM) or Dynamic Random Access Memory (DRAM).

The network interface 225 manages communication between the client device 110 and remote systems. The network interface 225 includes hardware communication devices such as a modem, Ethernet, or WiFi communicator as well as software protocols for managing communication.

The document viewer 235 parses documents received via the network interface 225 and presents them upon the display 240. The document viewer 235 preferably includes the ability to interpret HTML as well as most conventional document formats (Microsoft Word, Microsoft Excel, etc.) In one embodiment, the document viewer 235 is an application selector routine, that upon receiving a file across the network interface 225, determines a preferred application for viewing the file type and submits the file to the appropriate application, which then displays the document on the display 240. The document viewer can be a standardized application such as a web browser or an application specially configured for use with the proxy server 125. In an alternate embodiment, the document viewer 235 is a single application capable of displaying multiple file formats which independently receives and displays any received documents. In some embodiments, the document viewer 235 includes functionality for editing any received documents and either storing them in the data storage 240 or transmitting them back to the proxy server 125.

In some embodiments, the client system 110 is not configured to actually view files for which it has been granted permission by the proxy server. For example, if the client system 110 were a cell phone without significant display functionality, the client system could copy the files to remote locations, direct the proxy server to print them at remote printers, and perform other functions, but not actually view the files themselves.

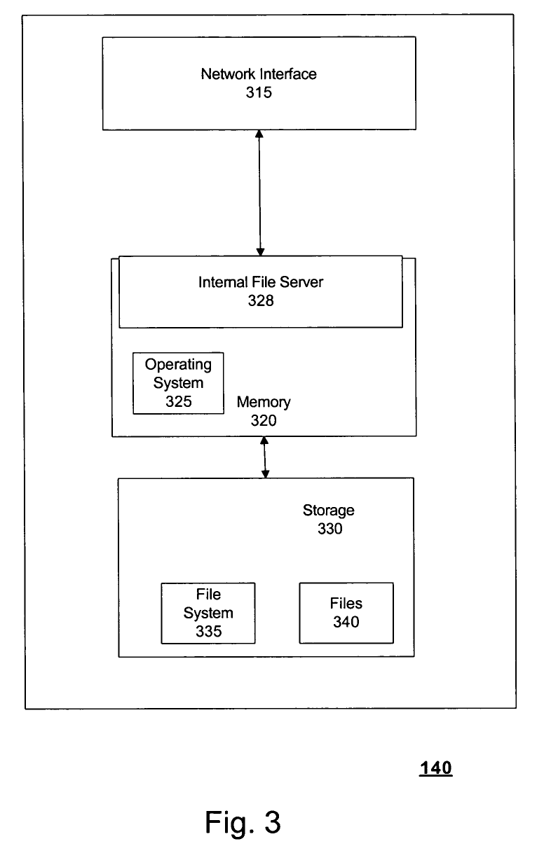

FIG. 3 is a closer view of a file source 140 in accordance with one embodiment of the present invention. The file source preferably includes a network interface 315, a memory 320, and a storage 330. The file source can be a personal computer, a file server, or a public use computer. The file source may be directly connected to the internet or stored behind a network firewall.

The network interface 315 maintains communication between the file source 140 and any devices attempting to access the storage 330. The network interface can be an Ethernet connection, modem, WiFi communicator, or any hardware capable of communicating with outside devices.

The memory 320 stores data in temporary use and maintains the operating system 325 which regulates access between the storage 330 and the network interface 315. The operating system 325 can include user identifiers and passwords which are used to regulate access to the storage 330. In one embodiment, the operating system 325 maintains an account for at least one user and restricts access to certain sections of the storage 330 to that user.

The storage 330 includes a file system 335 which maintains organizational information for the files 340 stored on the storage 330. The file system 335 maintains a directory structure, a time of last use for each of the files 340, access permissions for each of the files 340, and all other information needed to properly manage access to the files 340 by the operating system 325.

In one embodiment, the file source 140 includes an internal file server 328. The internal file server 328 is a module which is configured to manage interaction with the proxy server 125. In one embodiment, a internal file server sits on a single file source and manages interaction with the file source. In an alternate embodiment, a single file server 328 acts as a gateway for a number of file sources behind a firewall. The internal file server 328 manages secure access to the remote file source and works with the internal security configuration of either the file source itself or the network on which the file source sits to manage access control and authentication within the file system.

In some embodiments, the internal file server, the operating system 328, or some other agent, generates an interface that allows a user to share files through the proxy server in a similar manner to how files are shared with other parties on the sharer's network.

In additional embodiments, the file source does not include an internal file server 328 and the proxy server 125 logs in and interacts with the file source through a traditional client/server process maintained by the operating system 325.

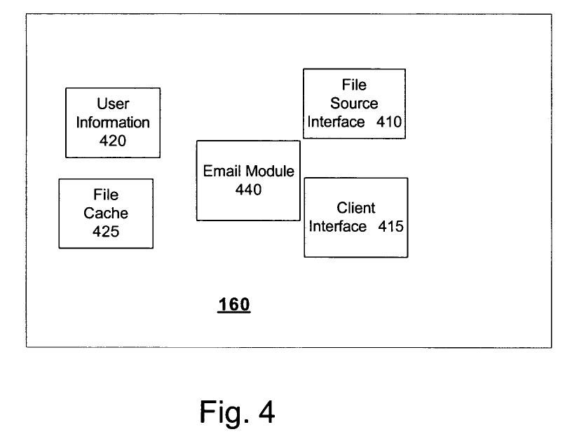

FIG. 4 is a closer view of the components of the memory of the proxy server 125 in accordance with one embodiment of the present invention. The modules include a file source interface 410, a client interface 415, user information 420, a file cache 425, and an authorization module 430, each of which provides some functionality for the proxy server 125. The modules 410, 415, 420, 425, 430 can be hardware, software, firmware, or any combination thereof.

The user information 420 stores customized user information for each of a number of users of the proxy server and is preferably located in the proxy database 138. The user information includes identification and authentication information for the users.

The file source interface 410 manages interaction between the proxy server 125 and the file sources 140, 145, and 150. The file source interface 410 can interface with the internal file servers 328 on the file sources through a single standardized API provided by each of the internal file servers, or customized front ends that are configured to interface with the file sources. The file source interface 410 is configured to receive general access instructions from the other modules and translate them to the format of the file source 140, 145, 150. For example, upon receiving a request for a file owned by user A and located on a Linux server, the file source interface would log into the Linux server, submit user A's ID and password information, log into the Linux server, navigate to the correct directory, and retrieve the file to the proxy server 125. Alternately, it could send the request to the internal file server located on the file source, which would itself locate the file and transmit it.

The client interface 415 generates a customized interface for the client system 110. This interface preferably includes a listing of shared files, and the ability to view and edit the files, either through capacities internal to the interface or by utilizing file viewers on the client system 110 itself. The client interface 415 receives commands from the client, translates them and passes them to the appropriate module. In one embodiment, the interface generated by the client interface 415 is a standard HTML interface. In an alternate embodiment, the client interface, upon initially being contacted by the client system, 110, determines its identity and capacities, and selects the interface best suited for the client system. For example, if the client system 110 were a cell phone, the client interface would generate a low bandwidth interface. In some embodiments, the proxy server 125 provides a standardized API for interacting with the file sources, and the client 110 is responsible for generating an interface based on information returned from the proxy server 125.

The file cache 425 stores locally available versions of files that are accessed by the proxy server 425. When a file is first accessed, the file source interface 410 retrieves the file from the file source 140. Any changes are stored in the local file cache 425. In one embodiment, when a session closes, the proxy server 125 evaluates the cache 425 to determine if any files have been changed. Any changed files are transferred back to the file source 140. In an alternate embodiment, the proxy server generates an interface that allows a user to edit the file directly on the file source 140 without caching the changes first.

The authorization module 420 is configured to manage access to remote files and modify the permissions stored in proxy representations. The authorization module 420, upon receiving a share request including an identifier of the user with whom the files are to be shared, modifies the permissions in the proxy representations to allow the recipient to access the new files. The authorization module is also configured to generate new user accounts and authenticate new users.

The memory also includes an email module 440. The email module is configured to receive outgoing electronic mail messages and modify or create proxy representations. When the proxy server receives an email message with an attachment or attachment location, the email module 440 modifies an existing proxy representation or creates a new one to grant the recipient access to the file associated with the sent message.

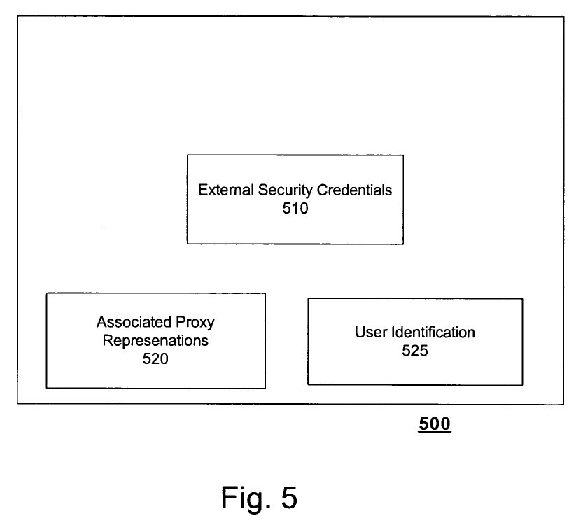

FIG. 5 is a closer view of a user file record 500 stored in the proxy database 138 in accordance with one embodiment of the present invention. The file record 500 is usually stored in the user information 420. Typically, the user information 420 includes multiple records, each record associated with a user.

The user record 500 includes user identification 525. The user identification 525 includes information used to identify the user. This can include an email address or any other mechanism of identification.

The user record 500 also includes security credentials 510 associated with the user. These credentials are used to verify the user's identity. These credentials typically include a username and password but can also include secure hardware keys or biometric data.

The associated proxy representations 520 store representations for those files that have been shared by remote users and indicates the level of access that has been granted. In some embodiments, there are no associated proxy representations in the user file and the proxy server determines to which files the user has been granted access by searching for proxy representations listing the user.

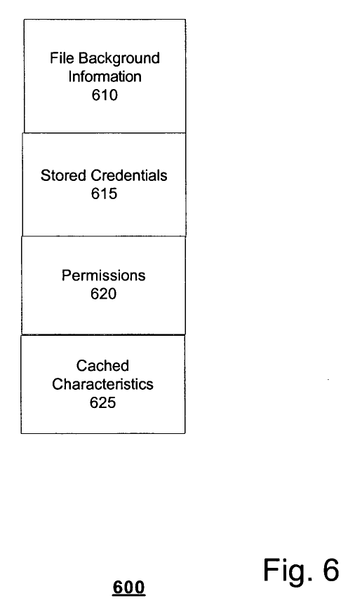

FIG. 6 is a closer view of a proxy representation 600 for a file or group of files. The proxy representation includes background information 605 of the file or group of files such as the file's original sharer, a file source, directory, and file name, an internal identifier for the file, and any other information which may be necessary to identify the file. The proxy representation 600 may also include stored credentials 610 that are needed to retrieve the file from the file source 140.

The proxy representation also includes permissions 620, the permissions indicating access controls for the file, specifically whether the remote user is permitted to read or write the file.

The proxy representation 600 also includes cached characteristics 625. The cached characteristics 625 indicate characteristics of a cached file when it was originally copied from a file source. These characteristics can include size, last modification time, a current location of the cached version, and any other relevant characteristics. The proxy server can use these characteristics to determine if the file has been modified by comparing a current last modification time of the cached version of the file to a cached last modification time and determining that the file has been modified if the current last modification time is later.

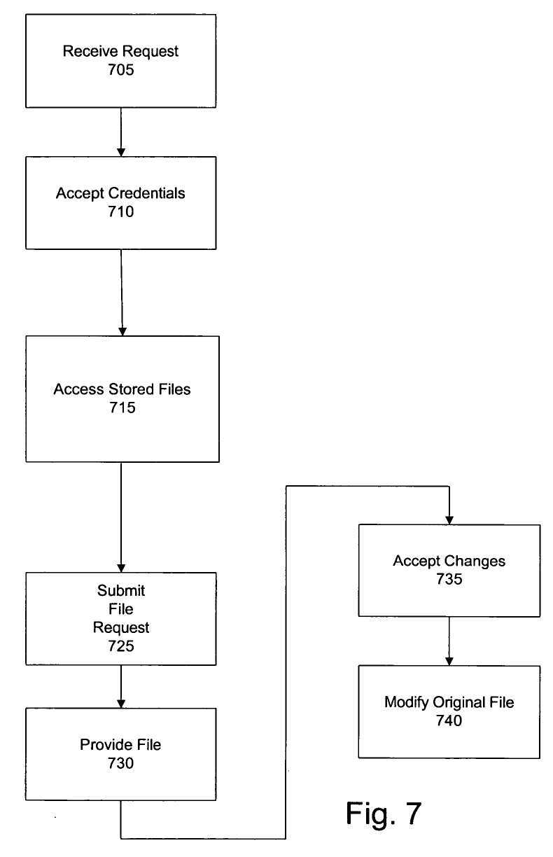

FIG. 7 is a flow chart illustrating one embodiment of a method for retrieving a shared file. The process begins 705 with the proxy server 125 receiving a request to access a file maintained on one of the file sources 140, 145, 150. In one embodiment, the request is received through a web portal or some manner of custom interface. In an alternate embodiment, an interface is generated on the client that is similar to a traditional file viewing interface.

The proxy server 125 then accepts 710 external credentials from the client 110 that are configured to identify and validate the user of the client system and verifies that the credentials are valid by checking the security credentials 510. These credentials typically include a username and password but can also include secure hardware keys or biometric data. The proxy server 125 then accesses 715 the stored files by submitting the security credentials stored in the proxy representation. The proxy server then submits 725 a request for the shared file to the file source 140. In an alternate embodiment, the proxy server does not maintain credentials and instead retrieves a locally stored cached version of the file.

Upon receiving the file, the proxy server then provides 730 the file to the user of the client system 110. If the remote user has write access to the file, the proxy server 125 can then accept 735 any changes made to the file. In one embodiment, these changes are initially stored in the file cache 425. In alternate embodiments, changes made to original versions of the file can be made directly, without separately caching the changes first. The proxy server 125, using the internal credentials provided by the sharer of the file, modifies the file. In one embodiment, when the sharer of the file next logs into the proxy server, he is notified that changes have been made to the original version of the file.

In an alternate embodiment, the proxy server does not maintain cached credentials and instead accepts changes to the cached version without automatically conveying the changes to the original. The sharer is then notified of the changes, either through a notification email or some manner of notification that is displayed when the sharer next logs into the proxy server or views the file within the proxy server. The proxy server can then update the original by accepting a request from the sharer and allowing the sharer to optionally resubmit the internal credentials needed to modify the file. In embodiments where the credentials are not cached, the resubmitted credentials can be provided when the sharer accepts the changes or when the sharer initially logs into the proxy server.

In addition to modifying the file, the proxy server can email the file or a reference to the file to a third party, route the file or a reference to the file to a remote printing or fax service, display the file, share the file with a third party, or perform any of a number of file-associated services.

FIG. 8 is a flow chart illustrating one embodiment of a process for sharing a file with a user by transmitting an electronic mail message. The process begins with the proxy server 125 receiving 805 the email message. In one embodiment the proxy server can receive a proxy generation request from an email client or email client plug-in on a sender computer that submits the request when a user attempts to send a message with an attachment. In an alternate embodiment, the proxy server allows a user to configure an email message through an HTML UI and select a file to be shared. In a third embodiment, the proxy server 125, either acting as an outgoing mail server or intermediate email proxy, intercepts a message with an attachment.

The proxy server then modifies 810 an existing proxy representation or creates a new proxy representation to grant the recipient access to the file associated with the transmitted email. The proxy server 125 preferably checks the recipient address for a user who already has access to the proxy and adds that user to the proxy representation. If no user can be detected, the proxy server generates a new record corresponding to that email address. In one embodiment, the proxy server or the email client then configures or modifies 815 the email message to insert a reference in the message that can direct the recipient to access the file through the proxy server 125. The reference can be a hyperlink, a data file, or an executable program.

The proxy server then transmits 820 the email message either to an outgoing mail server or to the incoming mail server of the recipient. If the recipient is a new user of the proxy server, the proxy server 125 later registers the recipient.

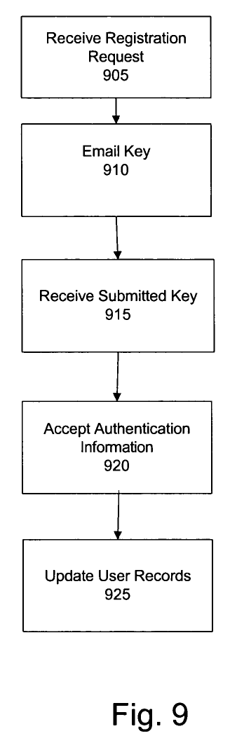

FIG. 9 is a flow chart illustrating one embodiment of a process for registering a user. The process begins with the proxy server 125 receiving a registration request. This request may be received when a new user attempts to establish an account on the proxy server 125 or can be generated when a user of the file sources attempts to share a file with a user lacking an account on the proxy server. Either form of request will include an email address for the new user. The proxy server then emails 910 a registration key to the new user at the listed address. The proxy server then accepts 920 authentication information in conjunction with the registration key from the new user which can be used to identify the user in the future. This information can be a username or password or an alternate mechanism of identification such as a secure hardware key or biometric data. In an alternate embodiment, the proxy server 125 generates the authentication information itself. This information is stored 925 in a user record 600 on the external proxy 135.

In addition to the authentication method described above, the proxy server can also employ an external authentication service, such as SecurID or a well known Lightweight Directory Access Protocol (LDAP) directory to verify the user's identity.

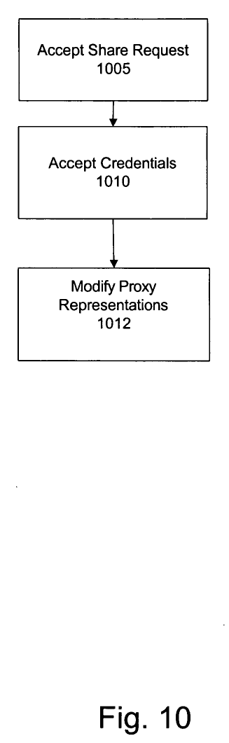

FIG. 10 is a flow chart illustrating one embodiment of a process for sharing a file on a file source 140, 145, 150. The process begins with the proxy server 125 accepting a share request 1005 from an internal user which includes a location of the file. In one embodiment, a user can submit a sharing request by selecting the file through a graphical user interface (GUI) and selecting a menu item (either centralized or pop-up) associated with generating a proxy representation.

If the user has stored credentials for the current file source, the process skips to step 1012. If the user has not stored credentials, the proxy server 125 then accepts 1010 credentials from the user that are necessary for the proxy server to access the shared file. These credentials may optionally be provided when the sharer first logs into the proxy server. In one embodiment, the proxy server stores the credentials in association with the proxy representation to provide remote users with access to the original version of the file. In alternate embodiments, the proxy server 125 uses the credentials initially to copy the file, stores the location of the copied file in the proxy representation, and then expunges or otherwise fails to store the credentials.

The proxy then updates 1012 an existing proxy representation or creates a new proxy representation in the proxy database 138. In one embodiment, the proxy server, upon generating the proxy representation, notifies the party with whom the file has been shared by generating a notification message which may include a link to the cached version of the file on the proxy server.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

1. A method for sharing files with remote users, the method comprising:
accepting a request from a file sharer to share a file with a remote user;
accessing credentials, the credentials configured to enable access to the file; and
generating a proxy representation for the file, the proxy representation associated with the remote user and storing a location of the file.

2. The method of claim 1, wherein accessing the credentials comprises accepting the credentials from the file sharer.

3. The method of claim 1, wherein accessing the credentials comprises retrieving previously stored credentials.

4. The method of claim 1, further comprising using the credentials to store a cached copy of the file in association with the proxy representation.

5. The method of claim 1, further comprising storing the credentials in association with the proxy representation.

6. The method of claim 1, further comprising:
accepting a view request from the remote user; and
enabling the remote user to view the file.

7. The method of claim 1, further comprising:
accepting a share request from the remote user; and
enabling the remote user to share the file with a third party.

8. The method of claim 1, further comprising:
accepting an email request from the remote user; and
transmitting an email associated with the file.

9. The method of claim 1, further comprising:
accepting a print request from the remote user; and
transmitting a print request associated with the file to a remote print service.

10. The method of claim 1, further comprising:
accepting a fax request from the remote user; and
transmitting a fax request associated with the file to a remote fax service.

11. The method of claim 1, wherein the request comprises a request generated by:
viewing a representation of the file within a graphical user interface;
selecting the representation of the file within the graphical user interface;
viewing a menu associated with the file, the menu displaying actions that can be performed on the file; and
selecting a share option from the menu.

12. The method of claim 1, wherein generating the proxy representation comprises generating a proxy representation configured to enable the remote user to modify the file.

13. The method of claim 1, wherein generating the proxy representation comprises generating a proxy representation configured to enable the remote user to read the file.

14. The method of claim 1, wherein storing credentials comprises accepting the credentials from the file sharer.

15. The method of claim 1, further comprising determining if a database entry associated with the remote user is stored on an account database.

16. The method of claim 15, further comprising storing the proxy representation in association with the database entry associated with the remote user in response to a positive determination.

17. The method of claim 15, further comprising generating a new database entry associated with the proxy representation for the remote user in response to a negative determination.

18. The method of claim 17, further comprising transmitting an email containing a registration key to the remote user.

19. The method of claim 1, further comprising accepting a retrieval request from the remote user.

20. The method of claim 19, further comprising using the credentials to retrieve the file.

21. The method of claim 19, wherein the retrieval request includes authentication information for the remote user.

22. The method of claim 19, further comprising providing access to a cached version of the file.

23. The method of claim 19, further comprising accepting a modification request from the remote user.

24. The method of claim 23, wherein the modification request includes authentication information.

25. The method of claim 23, further comprising using the credentials to modify the file.

26. The method of claim 23, further comprising:
modifying a cached version of the file in response to the modification request; and
notifying the file sharer that the cached version has been modified.

27. The method of claim 26, further comprising synchronizing the file with the cached version in response to a request from the file sharer.

28. The method of claim 25, further comprising notifying the file sharer that the file has been modified.

29. A system for sharing files with remote users, the system comprising:
a proxy database storing proxy representations, the proxy representations configured to enable access to files for remote users; and
a proxy configured to:
accept a request from a file sharer to share a file with a remote user;
access credentials, the credentials configured to enable access to the file; and
generate a proxy representation for the file.

30. The system of claim 29, wherein the proxy, when accessing the credentials, accepts the credentials from the file sharer.

31. The system of claim 29, wherein the proxy, when accessing the credentials, retrieves previously stored credentials.

32. The system of claim 29, wherein the proxy is further configured to use the credentials to store a cached copy of the file in association with the proxy representation.

33. The system of claim 29, wherein the proxy is further configured to store the credentials in association with the proxy representation.

34. The system of claim 29, wherein the proxy is further configured to:
accept a view request from the remote user; and
enable the remote user to view the file.

35. The system of claim 29, wherein the proxy is further configured to:
accept a share request from the remote user; and
enable the remote user to share the file with a third party.

36. The system of claim 29, wherein the proxy is further configured to:
accept an email request from the remote user; and
transmit an email associated with the file.

37. The system of claim 29, wherein the proxy is further configured to:
accept a print request from the remote user; and
transmit a print request associated with the file to a remote print service.

38. The system of claim 29, wherein the proxy is further configured to:
accept a fax request from the remote user; and
transmit a fax request associated with the file to a remote fax service.

39. The system of claim 29, wherein the request comprises a request generated by:
viewing a representation of the file within a graphical user interface;
selecting the representation of the file within the graphical user interface;
viewing a menu associated with the file, the menu displaying actions that can be performed on the file; and
selecting a share option from the menu.

40. The system of claim 29, wherein the proxy, when generating the proxy representation, generates a proxy representation configured to enable the remote user to modify the file.

41. The system of claim 29, wherein the proxy, when generating the proxy representation, generates a proxy representation configured to enable the remote user to read the file.

42. The system of claim 29, wherein the proxy when storing credentials, accepts the credentials from the file sharer.

43. The system of claim 29, wherein the proxy is further configured to determine if a database entry associated with the remote user is stored on an account database.

44. The system of claim 43, wherein the proxy is further configured to store the proxy representation in association with the database entry associated with the remote user in response to a positive determination.

45. The system of claim 43, wherein the proxy is further configured to generate a new database entry associated with the proxy representation for the remote user in response to a negative determination.

46. The system of claim 45, wherein the proxy is further configured to transmit an email containing a registration key to the remote user.

47. The system of claim 29, wherein the proxy is further configured to accept a retrieval request from the remote user.

48. The system of claim 47, wherein the proxy is further configured to use the credentials to retrieve the file.

49. The system of claim 47, wherein the retrieval request includes authentication information for the remote user.

50. The system of claim 47, wherein the proxy is further configured to provide access to a cached version of the file.

51. The system of claim 29, wherein the proxy is further configured to accept a modification request from the remote user.

52. The system of claim 51, wherein the modification request includes authentication information.

53. The system of claim 51, wherein the proxy is further configured to use the credentials to modify the file.

54. The system of claim 51, wherein the proxy is further configured to:
modify a cached version of the file in response to the modification request; and
notify the file sharer that the cached version has been modified.

55. The system of claim 54, wherein the proxy is further configured to synchronize the file with the cached version in response to a request from the file sharer.

56. The system of claim 53, wherein the proxy is further configured to notify the file sharer that the file has been modified.

57. A computer program product, stored on a computer readable medium, and including computer executable instructions for controlling a processor to manage access to remote files, the instructions comprising instructions for:
accepting a request from a file sharer to share a file with a remote user;
accessing credentials, the credentials configured to enable access to the file; and
generating a proxy representation for the file, the proxy representation associated with the remote user and storing a location of the file.

58. The computer program product of claim 57, wherein the instructions for accessing the credentials comprise instructions for accepting the credentials from the file sharer.

59. The computer program product of claim 57, wherein the instructions for accessing the credentials comprise instructions for retrieving previously stored credentials.

60. The computer program product of claim 57, further comprising instructions for using the credentials to store a cached copy of the file in association with the proxy representation.

61. The computer program product of claim 57, further comprising instructions for storing the credentials in association with the proxy representation.

62. The computer program product of claim 57, further comprising instructions for:
accepting a view request from the remote user; and
enabling the remote user to view the file.

63. The computer program product of claim 57, further comprising instructions for:
accepting a share request from the remote user; and
enabling the remote user to share the file with a third party.

64. The computer program product of claim 57, further comprising instructions for:
accepting an email request from the remote user; and
transmitting an email associated with the file.

65. The computer program product of claim 57, further comprising instructions for:
accepting a print request from the remote user; and
transmitting a print request associated with the file to a remote print service.

66. The computer program product of claim 57, further comprising instructions for:
accepting a fax request from the remote user; and
transmitting a fax request associated with the file to a remote fax service.

67. The computer program product of claim 57, wherein the request comprises a request generated by:
viewing a representation of the file within a graphical user interface;
selecting the representation of the file within the graphical user interface;
viewing a menu associated with the file, the menu displaying actions that can be performed on the file; and
selecting a share option from the menu.

68. The computer program product of claim 57, wherein the instructions for generating the proxy representation comprise instructions for generating a proxy representation configured to enable the remote user to modify the file.

69. The computer program product of claim 57, wherein the instructions for generating the proxy representation comprise instructions for generating a proxy representation configured to enable the remote user to read the file.

70. The computer program product of claim 57, wherein the instructions for storing credentials comprise instructions for accepting the credentials from the file sharer.

71. The computer program product of claim 57, further comprising instructions for determining if a database entry associated with the remote user is stored on an account database.

72. The computer program product of claim 71, further comprising instructions for storing the proxy representation in association with the database entry associated with the remote user in response to a positive determination.

73. The computer program product of claim 71, further comprising instructions for generating a new database entry associated with the proxy representation for the remote user in response to a negative determination.

74. The computer program product of claim 73, further comprising instructions for transmitting an email containing a registration key to the remote user.

75. The computer program product of claim 57, further comprising instructions for accepting a retrieval request from the remote user.

76. The computer program product of claim 75, further comprising instructions for using the credentials to retrieve the file.

77. The computer program product of claim 75, wherein the retrieval request includes authentication information for the remote user.

78. The computer program product of claim 75, further comprising instructions for providing access to a cached version of the file.

79. The computer program product of claim 77, further comprising instructions for accepting a modification request from the remote user.

80. The computer program product of claim 79, wherein the modification request includes authentication information.

81. The computer program product of claim 79, further comprising instructions for using the credentials to modify the file.

82. The computer program product of claim 79, further comprising instructions for:
modifying a cached version of the file in response to the modification request; and
notifying the file sharer that the cached version has been modified.

83. The computer program product of claim 82, further comprising instructions for synchronizing the file with the cached version in response to a request from the file sharer.

84. The computer program product of claim 81, further comprising instructions for notifying the file sharer that the file has been modified.

85. A method for enabling access to files, the method comprising:
receiving a sending request for an email message from a file sharer, the sending request associated with a recipient and a file having a file location; and
creating a proxy representation for the file, the proxy representation configured to enable the recipient to access the file; and
storing a reference in the message, the reference associated with the proxy representation.

86. The method of claim 85, wherein receiving the sending request comprises accepting a sending request for the email message through a HyperText Markup Language (HTML) interface, the sending request including the file location.

87. The method of claim 85, wherein receiving the sending request comprises:
intercepting the email message; and
separating a file attachment comprising a copy of the file from the email message.

88. The method of claim 85, wherein:
receiving the sending request comprises receiving the sending request for the email message through an email client, the sending request including the file location; and
creating the proxy representation comprises sending a proxy representation creation request to a remote server.

89. The method of claim 85, further comprising storing credentials, the credentials configured to enable access to the file.

90. The method of claim 85, wherein the proxy representation is associated with a cached copy of the file.
